(19) United States
(12) Patent Application Publication
(10) Pub. No.: US 2017/0152946 A1
(43) Pub. Date: Jun. 1, 2017

(54) SEQUENTIAL SHIFT TRANSMISSION

(71) Applicant: TEAM Industries, Inc., Bagley, MN (US)

(72) Inventors: Gregory L. Maki, Solway, MN (US); Brian Thomas Wolf, Bemidji, MN (US)

(21) Appl. No.: 15/360,206

(22) Filed: Nov. 23, 2016

Related U.S. Application Data
(60) Provisional application No. 62/260,377, filed on Nov. 27, 2015.

(51) Int. Cl. F16H 63/18; B60K 17/344; F16H 37/04; F16H 3/091

(52) U.S. Cl. CPC F16H 63/18; F16H 3/091; B60K 17/344; F16H 37/043; F16H 2037/045

(57) ABSTRACT

A sequential shift transmission is provided that includes a transmission portion, a range box portion, a transfer portion and at least one shift actuator. The transmission portion has sequential gearing. The range box portion is operationally coupled to the transmission portion and has range gearing that includes a low range gear and a high range gear. The transfer portion is operationally coupled to the range box portion to output torque from the sequential shift transmission. The at least one shift actuator is configured and arranged to selectively change the sequential gearing and the range gearing.

### CROSS-REFERENCE TO RELATED APPLICATIONS

This Application claims priority to U.S. Provisional Application Ser. No. 62/260,377, same title herewith, filed on Nov. 27, 2015, which is incorporated in its entirety herein by reference.

### BACKGROUND

A sequential shift gear box is a gearbox containing multiple discrete gear ratios. Gear shifting occurs typically via a shift cam mechanism (ex. rotary shift drum) that moves the shift forks sequentially through the gear ratios. During operation one has to shift to the next higher or next lower gear ratio in this system. For example, it is physically impossible to shift directly from 1^{st} gear to 4^{th} gear due to how the shifting cam has a specific, physical order to the shifting. Another common trait in a typical sequential shift gear box is that the shifting mechanism has an indexer. An operator moves the indexer through its full range of motion with a shift lever, which in turn causes the transmission to advance by one gear.

In the case of automated shifting via pneumatic, electric, or hydraulic means, the same functional characteristics apply. In this system an actuator can travel its full range and only index the shift cam by one gear position. Analog rotary position feedback of the shift cam to a controller is not needed to stop the shift cam actuator at a specific position. A mechanical index mechanism takes care of the travel stops. The mechanical indexer/shift lends itself to quick shifts. This type of gear box is typically found in motorcycle applications. A foot shift lever is depressed to index “up” or “down” one gear at a time. Another common application is performance automobiles used for racing.

Typical motorcycle applications are relatively low mass vehicles that do not need to operate under high torque/low speed conditions, such as those for utility work. Typical automobile performance/racing applications are also not intended to operate under steady state high torque/low speed conditions found in utility work or special off-road conditions such as “rock crawling.”

For the reasons stated above and for other reasons stated below which will become apparent to those skilled in the art upon reading and understanding the present specification, there is a need in the art for a sequential shift transmission that provides both a high and low range.

### SUMMARY OF INVENTION

The above-mentioned problems of current systems are addressed by embodiments of the present invention and will be understood by reading and studying the following specification. The following summary is made by way of example and not by way of limitation. It is merely provided to aid the reader in understanding some of the aspects of the invention.

In one embodiment, a sequential shift transmission is provided. The sequential shift transmission includes a transmission portion, a range box portion, a transfer portion and at least one shift actuator. The transmission portion has sequential gearing. The range box portion has range gearing that includes a low range gear and a high range gear and is operationally coupled to the transmission portion. The transfer portion is operationally coupled to the range box portion to output torque from the sequential shift transmission. The at least one shift actuator is configured and arranged to selectively change the sequential gearing and the range gearing.

Further in an embodiment, the at least one shift actuator uses a single input to control shifting of both the sequential gearing and the range gearing.

Further in an embodiment, the single input is provided by one of a mechanical shift lever, an electric motor actuator, a hydraulic actuator and a pneumatic actuator.

Further in an embodiment, the sequential shift transmission includes a park gear that is activated by the at least one shift actuator.

Further in an embodiment, the at least one shift actuator further includes a sequential gear shifting assembly and a gear range shifting assembly. The sequential gear shifting assembly is configured and arranged to shift the sequential gearing. The gear range shifting assembly is configured and arranged to shift the range gearing.

Further in an embodiment, the sequential gear shifting assembly includes a shift drum, at least one sequential shift fork and at least one sequential shaft shift dog. The shift drum has at least one track. The at least one sequential shift fork is operationally engaged with the at least one track. The at least one sequential shaft shift dog is operationally engaged with the at least one sequential shift fork. The at least one sequential shaft shift dog is configured and arranged to selectively lock rotation between a select gear of the sequential gearing and a sequential shaft to change gearing of the sequential gearing based on movement of the at least one sequential shift fork. The sequential transmission further includes a gear range shifting assembly. The gear range shifting assembly including a gear range shaft, a gear range shift fork and a gear range shaft shift dog. The gear range shaft is in operational engagement with the shift drum. The gear range shift fork is operationally engaged to the gear range shaft. The gear range shaft shift dog is operationally engaged with the range gearing. The gear range shaft shift dog is configured and arranged to selectively lock rotation between one of the low gear and the high range gear and an intermediate shaft to change gearing of the range gearing based on movement of the gear range shift fork. The intermediate shaft is operationally coupled to the transfer portion of the sequential shift transmission.

Further in an embodiment, the shift drum includes an end with a cam surface. An end of the gear range shaft engages the cam surface of the shift drum. The biasing member is positioned to bias the gear range shaft against the cam surface, wherein rotation of the shift drum causes movement of the gear range shaft to change the range gearing in the range box.

Further in an embodiment the transfer portion includes at least one output that is configured and arranged to be operationally coupled to a drive shaft.

Further in an embodiment, the transfer portion further includes a first output and a second output. The first output is configured and arranged to be coupled to a first drive train. The second output is operationally coupled to the first output. The second output is configured and arranged to be coupled to a second drive train.

Further in an embodiment, the second output is positioned to not be coaxial with the first output.

Further in an embodiment, the sequential shift transmission further includes a reduction gear set that is positioned at least within one of the transmission portion and the transfer portion.

In another embodiment, yet another sequential shift transmission is provided. The sequential shift transmission includes a transmission portion, a range box portion, a transfer portion and a shift actuator. The transmission portion has sequential gearing. The range box portion has range gearing including a low range and a high range. The range box portion is operationally coupled to the transmission portion. The transfer portion is operationally coupled to the range box portion to output torque from the sequential shift transmission. The transfer portion includes a reduction gear set. The shift actuator is configured and arranged to selectively change both the sequential gearing and the range gearing of the sequential shift transmission.

Further in an embodiment, the shift actuator further includes a sequential gear shifting assembly and a gear range shifting assembly. The sequential gear shifting assembly is configured and arranged to shift the sequential gearing. The gear range shifting assembly is configured and arranged to shift the range gearing.

Further in an embodiment, the sequential gear shifting assembly includes a shift drum, at least one sequential shift fork and at least one sequential shaft shift dog. The shift drum has at least one track. The at least one sequential shift fork is operationally engaged with the at least one track. The at least one sequential shaft shift dog is operationally engaged with the at least one sequential shift fork. The at least one sequential shaft shift dog is configured and arranged to selectively lock rotation between a select gear of the sequential gearing and a sequential shaft to change gearing of the sequential gearing based on movement of the at least one sequential shift fork. The sequential transmission further includes a gear range shifting assembly. The gear range shifting assembly including a gear range shaft, a gear range shift fork and a gear range shaft shift dog. The gear range shaft is in operational engagement with the shift drum. The gear range shift fork is operationally engaged to the gear range shaft. The gear range shaft shift dog is operationally engaged with the range gearing. The gear range shaft shift dog is configured and arranged to selectively lock rotation between one of the low gear and the high range gear and an intermediate shaft to change gearing of the range gearing based on movement of the gear range shift fork. The intermediate shaft is operationally coupled to the transfer portion of the sequential shift transmission.

Further in an embodiment, the shift drum includes an end with a cam surface. An end of the gear range shaft engages the cam surface of the shift drum. The basing member is positioned to bias the gear range shaft against the cam surface, wherein rotation of the shift drum causes movement of the gear range shaft to change the range gearing in the range box.

In another embodiment, a vehicle is provided. The vehicle includes an engine, a sequential shift transmission, a clutch and at least one wheel. The engine provides torque. The sequential shift transmission includes a transmission portion, a range box portion and a transfer portion. The transmission portion has a sequential gearing arrangement for a plurality of gears. The range box portion has range gearing that includes a low range and a high range operationally coupled to the transmission portion. The transfer portion is operationally coupled to the range box portion. The transfer portion is configured and arranged to output torque from the transmission. The clutch selectively couples the torque from the engine to the transmission portion. The at least one wheel is operationally coupled to the transfer portion of the transmission.

Further in an embodiment the vehicle further includes at least one drive shaft operationally coupled to the transfer portion.

Further in an embodiment, the at least one shift actuator is configured and arranged to selectively change the sequential gearing and the range gearing.

Further in an embodiment, the at least one shift actuator further includes a sequential gear shifting assembly and a gear range shifting assembly. The sequential gear shifting assembly is configured and arranged to shift the sequential gearing. The gear range shifting assembly is configured and arranged to shift the range gearing.

Further in an embodiment, the sequential gear shifting assembly includes a shift drum, at least one sequential shift fork and at least one sequential shaft shift dog. The shift drum has at least one track. The at least one sequential shift fork is operationally engaged with the at least one track. The at least one sequential shaft shift dog is operationally engaged with the at least one sequential shift fork. The at least one sequential shaft shift dog is configured and arranged to selectively lock rotation between a select gear of the sequential gearing and a sequential shaft to change gearing of the sequential gearing based on movement of the at least one sequential shift fork. The sequential transmission further includes a gear range shifting assembly. The gear range shifting assembly including a gear range shaft, a gear range shift fork and a gear range shaft shift dog. The gear range shaft is in operational engagement with the shift drum. The gear range shift fork is operationally engaged to the gear range shaft. The gear range shaft shift dog is operationally engaged with the range gearing. The gear range shaft shift dog is configured and arranged to selectively lock rotation between one of the low gear and the high range gear and an intermediate shaft to change gearing of the range gearing based on movement of the gear range shift fork. The intermediate shaft is operationally coupled to the transfer portion of the sequential shift transmission.

### BRIEF DESCRIPTION OF THE DRAWINGS

The present invention can be more easily understood and further advantages and uses thereof will be more readily apparent, when considered in view of the detailed description and the following figures in which:

FIG. 1 illustrates a block diagram of a vehicle with a sequential shift transmission of one embodiment of the present invention;

FIG. 2 is first side view of components of a sequential shift transmission of an embodiment illustrating a torque path through the sequential shift transmission;

FIG. 2A illustrates a partial side view of a sequential transmission illustrating a different configuration of the transfer portion of an embodiment of the present invention;

FIG. 3 is a second side view of the components of the sequential shift transmission of the embodiment of FIG. 2 illustrating a shifting system of an embodiment;

FIG. 4 is a side perspective view of the sequential shift transmission of FIG. 2;

FIG. 5 is an end view of the sequential shift transmission of FIG. 2;

FIG. 6A is a block diagram of a sequential shift transmission of another embodiment of the present invention; and

FIG. 6B is a block diagram of a sequential shift transmission of yet another embodiment of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

Embodiments of the present invention provide a sequential shift transmission with a range box portion that provides a high and low range in addition to the typical 4, 5, 6, etc. speed sequential gear sets. The low range accommodates high torque/low speed operating conditions such as utility work or “rock crawling.” The high range may be used for “normal” driving conditions such as trail riding or on-road driving. Depending on ratios used in “driving” and “range” gears, the range selection gears may also be used to expand the number of discrete ratios available without having to add significantly more gears, weight, and cost. Moreover, the overall ratio spread of the gear box may be expanded to improve vehicle performance over a wider range of conditions. In an embodiment, the transmission may be configured so that the input shaft is in-line with the engine crankshaft and clutch. Moreover in embodiments the transmission may also be configured to utilize a “primary gear set” to step down speed going into the shifting gears. A clutch may be placed on an input between an engine and a transmission, or after the primary reduction set in embodiments. Moreover, embodiments of the transmission may be configured to have a common axis front and rear output shaft, or offset output shafts depending on vehicle layout requirements. In addition, shifting may be setup up to utilize one actuation input to shift both the sequential gearing and the range gearing. In another embodiment, separate inputs are used to actuate a change in sequential gearing and range gearing.

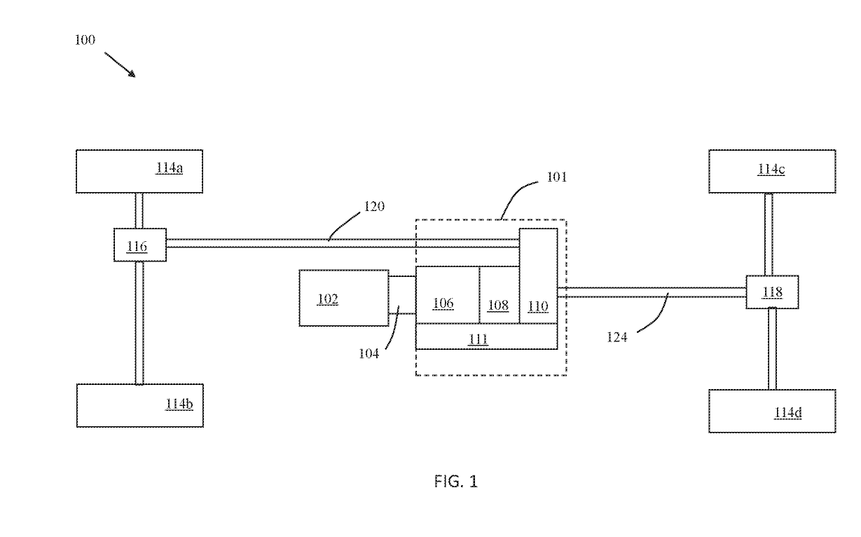

Referring to FIG. 1, a block diagram of a vehicle 100 of an embodiment is illustrated. The vehicle 100 includes an engine 102 that provides torque to a transmission 101 via clutch 104. The transmission 101 provides torque to a front axle gear box 116 via front propeller shaft 120 (front drive shaft). The front axle gear in turn provides torque to at least one of the front wheels 114a and 114b. The transmission 101 further provides torque to a rear axle gear box 118 via rear propeller shaft 124 (rear drive shaft). The rear axle gear box 118 in turn provides torque to at least one of the rear wheels 114c and 114d. The transmission 101 of the embodiment of FIG. 1 includes a transmission portion 106, a range box portion 108, a transfer portion 110 and an actuator portion 111. Embodiments of the transmission portion 106, the range portion 108, the transfer portion 110 and the actuator portion 111 are described in detail below.

The embodiments of the sequential transmission described herein provide an additional range gear set in parallel to a reduction gear set and downstream from the sequential gearing (driving gears). This allows the downstream reduction stage to have a high and low ratio choice, making this stage into the range box portion 108 within the transmission 101. Embodiments increase the gear ratio combinations and provide the ability of having a large speed reduction ratio for the “extra-low” first and reverse gear without incorporating extreme size proportion gearing. Having the range gears also offers an ability to expand the total number of unique gear ratios, in addition to just adding an extra gear ratio at one end of the range. For example, a transmission having reverse=5:1, first=5:1, second=4:1, third=3:1, fourth=2:1, and fifth=1:1 is possible. The extra reduction set is added to create a high/low range box having high=1:1 and low=1.5:1. If it is desired to have more ratios to allow for optimization of vehicle performance, reverse ratios of 7.5:1 and 5:1 may be used, plus forward ratios of 7.5:1, 6:1, 5:1, 4.5:1, 4:1, 3:1, 2:1, 1.5:1 and 1:1. An extra five gear ratios were created by only adding one gear set and shift dog. The number of usable gear ratios created by adding the extra range gear will depend on the specific numerical gear ratios of the shift-able drive gears (reverse, first-nth). In addition, embodiments integrate the range box gearing into the sequential shift gear box. This allows the ability to shift both the driving gears and range gears using a single shift input device, such as a mechanical linkage, electric, hydraulic, or pneumatic actuator. Moreover, in an embodiment, a separate shifting input is used. In addition, in an embodiment, the transmission portion 106 includes a park gear that is activated the actuator portion 111. In one embodiment, the actuator portion 111 includes a separate park activation mechanism.

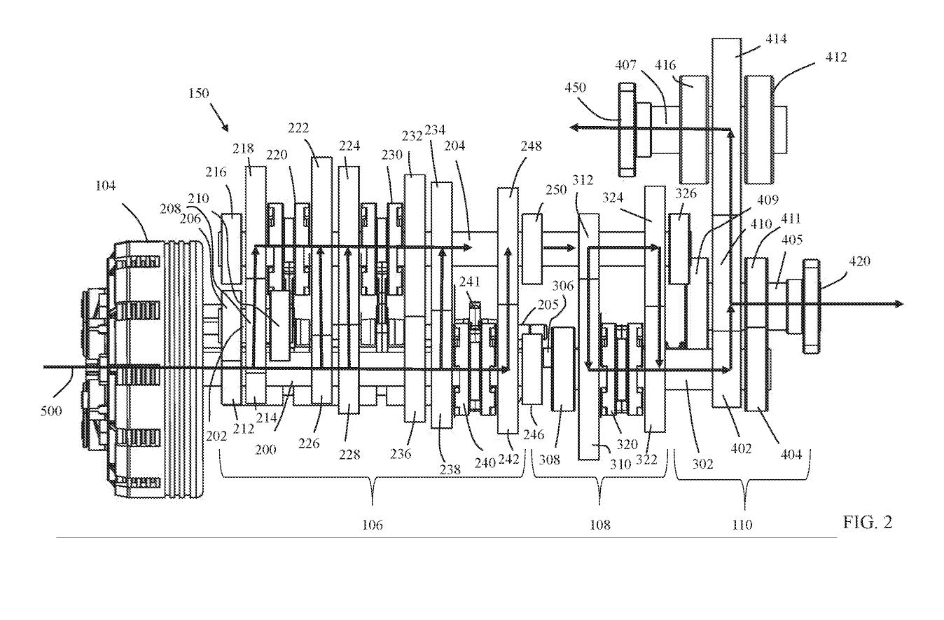

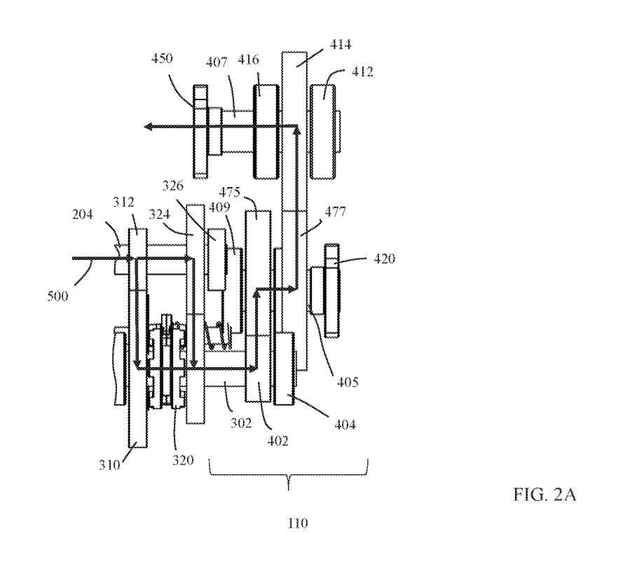

Referring to FIG. 2, a sequential shift transmission 150 of one embodiment is illustrated. FIG. 2 illustrates a power flow (torque path) 500 in this design to a first output 420 and a second output 450. This example embodiment includes five forward speeds and one reverse with a high/low range. It will be understood that other numbers of the forward speeds could be used and other ranges for a reverse gear could also be used. The gears in the Figures are shown as cylindrical pucks, without gear teeth. This is for illustration purposes only. The gears would typically have mating gear teeth to transfer rotation. Moreover, for illustrative purpose, portions of transmission housings (casings) that would engage and support various bearings described below are not shown.

The sequential shift transmission 150 includes an input shaft 200 that is operationally coupled to the clutch 104. The input shaft 200 receives torque from the engine 102 via the clutch 104. The clutch 104 is designed to selectively disconnection torque between the engine 102 and the input shaft 200. In one embodiment, the input shaft 200/clutch 104 is directly coupled to the engine crankshaft (not shown) to eliminate gear backlash between the engine 102 and the transmission inertias. Mounted on the input shaft 200, in this example embodiment is bearing 212, reverse input shaft gear 214, a first input shaft gear 226, a second input shaft gear 228, third input shaft gear 236, fourth input shaft gear 238, fifth input shaft gear 242 and input shaft shift dog 240. The input shaft shift dog 240 is mounted to the input shaft 200 between the fourth input shaft gear 238 and the fifth input shaft gear 242. The input shaft shift dog 240 uses jaw clutches to connect rotation of the input shaft 200 to a select gear. The input shaft shift dog 240 and counter shaft shift dogs 220 and 230 described below (generally referred to as sequential shift shaft dogs) in other embodiments may be located in different locations. For example, they could all be mounted on the input shaft 200, all be mounted on the counter shaft 204 or any combination thereof. Further mounted on the input shaft 200 is bearing 246 which in part supports (via housing cover, not shown) the input shaft 200. As illustrated in FIG. 2, the torque path 500 enters into the input shaft 200 via clutch 104. Rotation of the input shaft 200 results in the rotation of the reverse input shaft gear 214, the first input shaft gear 226, the second input shaft gear 228, and the third input shaft gear 236. Moreover, depending on the setting of the input shaft shift dog 240, rotation of the input shaft 200 may be transferred to one of the fourth and fifth input shaft gears 238 and 242. In an embodiment, a chain/sprocket arrangement is used instead of the gear pair, reverse input shaft gear 214 and idler gear 208.

The sequential shift transmission 150 further includes a counter shaft 204. Mounted on the counter shaft is bearing 216, idler counter shaft reverse gear 218, first counter shaft shift dog 220, first counter shaft gear 222, second counter shaft gear 224, second counter shaft shift dog 230, third counter shaft gear 232, fourth counter shaft gear 234, fifth counter shaft gear 248 and bearing 250. In another embodiment, bearing 250 is not included on the counter shaft 204. The first counter shaft gear 222 is rotationally coupled to the first input shaft gear 226 of the input shaft 200. The second counter shaft gear 224 is rotationally coupled to the second input shaft gear 228 of the input shaft 200. The third counter shaft gear 232 is rotationally coupled to the third input shaft gear 236 of the input shaft 200. The fourth counter shaft gear 234 is rotationally coupled to the fourth input shaft gear 238 of the input shaft 200. The fifth counter shaft gear 248 is rotationally coupled to the fifth input shaft gear 242 of the input shaft 200.

The first counter shaft shift dog 220 is positioned between the idler counter shaft reverse gear 218 and the first counter shaft gear 222 to selectively lock rotation of one of the idler counter shaft reverse gear 218 or the first counter shaft gear 222 to the counter shaft 204. The second counter shaft shift dog 230 is positioned between the second counter shaft gear 224 and the third counter shaft gear 232 to selectively lock rotation of one of the second counter shaft gear 224 or the third counter shaft gear 232 to the counter shaft 204. The sequential shift transmission 150 further includes an idler shaft 202. Mounted on the idler shaft 202 (best shown in FIG. 3), is a pair of bearings 206 and 210 and an idler gear 208. The idler gear 208 is rotationally couples the idler counter shaft reverse gear 218 of the counter shaft 204 to the reverse input shaft gear 214 of the input shaft 200. The idler shaft 202 and idler gear 208 is used for reverse to transmit torque from the input shaft 200 to the counter shaft 204. In an embodiment, a chain/sprocket arrangement is used instead of the gear pair, reverse input shaft gear 214 and idler gear 208.

The counter shaft 204 further has mounted thereon a counter shaft low range gear 312, a counter shaft high range gear 234 and a bearing 326. Torque 500 passes through either the counter shaft low range gear 312 or the counter shaft high range gear 324 to an intermediate shaft 302. In particular, mounted on intermediate shaft 302 is bearing 308, an intermediate shaft low range gear 310, an intermediate shaft shift dog 320, an intermediate shaft high range gear 322, an intermediate shaft reduction gear 402 and a bearing 404. The counter shaft low gear range gear 312 is rotationally coupled to the intermediate shaft low range gear 310 and the counter shaft high range gear 324 is rotationally coupled to the intermediate shaft high range gear 322. The intermediate shaft shift dog 320 is designed to selectively couple rotation of the intermediate shaft low range gear 310 or the intermediate shaft high gear 322 to the intermediate shaft 302. In another embodiment the intermediate shaft shift dog 320 (gear range shaft shift dog), may be mounted on the counter shaft 204 to selectively couple either the counter shaft low range gear 312 or the counter shaft high range gear 324 to the counter shaft 204. Further in one embodiment, one or more synchronizer clutches are used to couple the desired gear to a particular shaft instead of the shift dogs 220, 230, 240 and 320.

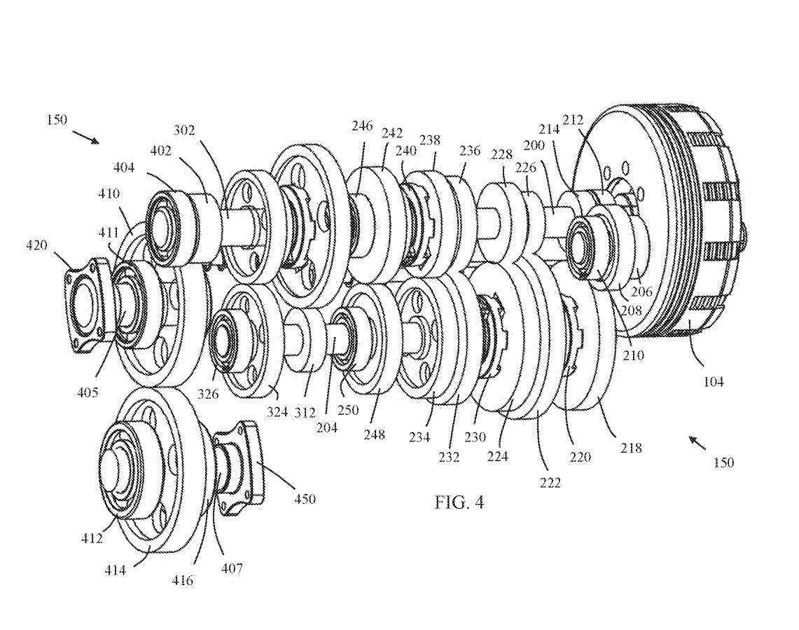

As illustrated in FIG. 2, torque 500 is passed along to output 420 and output 450 via a first output shaft 405 and second output shaft 407. Mounted on the first output shaft 405 is a first output stage gear 410, bearing 409 and bearing 411. The first output stage gear 410 is rotationally coupled to the intermediate shaft reduction gear 402. Output 420 include a drive shaft coupler that is configured to couple the output 420 to the rear drive shaft 124. The second output shaft 407 has mounted thereon bearing 412, a second output stage gear 414 and bearing 416. The second output stage gear 414 is rotationally coupled to the first output stage gear 410 of the first output shaft 405. That is, the first output stage gear 410 also functions as an idler gear to transmit torque to the second output stage gear 414. In the example embodiment shown in FIG. 2, the first output stage gear 410 and the second output stage gear 414 are a 1:1 set. The output 450 of the second output shaft 407 includes a drive shaft coupler to couple the output 450 to the front drive shaft 120. As illustrated, the torque 500 is transferred from the intermediate shaft reduction gear 402 of the intermediate shaft 302 to the first output 420 via the first output stage gear 410 and the second output 450 via the second output stage gear 414. In this configuration, the first output shaft 405 will have an opposite rotation than the second output shaft 407 as viewed from the end of the first output shaft 405 in FIG. 5. If it is desired to have both the first output shaft 405 and the second output shaft 407 having the same rotation direction, a chain and sprocket arrangement can be used in place of the first output stage gear 410 and the second output stage gear 414. In addition, if the first output stage gear 410 and the second output stage gear 414 have the same number of teeth, the two output shafts 405 and 407 will have the same rotational speed. If it is desired to have different rotational speeds, the first output stage gear 410 and the second output stage gear 414 may have a different number of teeth to achieve a different overall ratio. For example, if tire sizes on one axle were different than on the other and/or if the front axle gear box had a different ratio than the rear axle gear box then a different overall ratio may be desired. In addition, to meet various vehicle chassis configurations, the first output 420 and the second output 450 axis locations can be moved as needed. Moreover, shaft center distances can be adjusted by modifying the output stage gear pitch and diameters. In addition, the first output shaft 405 axis can be rotated about the intermediate shaft 302 axis. Similarly, the second output shaft 407 could be rotated about the first output shaft 405 axis.

FIG. 2A illustrates a partial side view of a sequential transmission illustrating a different configuration of the transfer portion 110. In this alternative embodiment, the intermediate shaft reduction gear 402 of the intermediate shaft 302 is rotationally coupled to a first output transfer gear 475 that is mounted on the first output shaft 405. Also mounted on the first output shaft 405, in this embodiment, is a second output transfer gear 477. It is the second output transfer gear 477 in this embodiment that is coupled to the second output stage gear 414. As illustrated, the torque 500 in this embodiment passes from the intermediate shaft reduction gear 402 to the first output transfer gear 475 and then to the second output transfer gear 477 via the first output shaft 405. The torque 500 is then transferred from the second output transfer gear 477 to the second output stage gear 414. Hence in this embodiment, instead of the first output shaft gear 410 being an idler gear that drives the second output stage gear 414 (as illustrated in FIG. 2), a separate gear set (the second output transfer gear 477 and the second output stage gear 414) is used to couple the first and second outputs 420 and 450. This allows the gear set connecting the intermediate shaft 302 and the first output shaft 405 to be used to adjust the overall ratio of the entire driveline without having to change any of the sequential or range gears, while at the same time allowing the first and second output axis to remain in their original fixed positions with a specific ratio between them. In the first embodiment of FIG. 2, although the intermediate shaft reduction gear 402 and the first output shaft gear 410 may be used to adjust overall driveline gear ratios, if the ratio of the intermediate shaft reduction gear 402 and the first output shaft gear 410 is changed, the pitch diameter of the first output shaft gear 410 would also have to be changed, which in turn affects the mesh between the first output shaft gear 410 and the second output stage gear 414. For example, if larger overall reduction was desired, gear 402 would be smaller while first output shaft gear 410 would be bigger. If the first output shaft gear 410 gets larger, but the second output shaft 407 needs to be in the same position, then the second output stage gear 414 would have to get smaller, but that would force the ratio between the first and second outputs 420 and 450 to be changed as well.

In addition, instead of gears connecting first and second output shafts 405 and 407, a chain and sprocket arrangement could be used. With the use of gears, the first and second outputs 420 and 450 would have opposite rotations. With a chain, the rotations would be in the same direction. Additionally, if a chain were used, it could allow the second output shaft axis to be positioned a further distance from the first output shaft axis using sprockets with relatively small pitch diameters. If gears were used for this scenario where the first and second outputs 420 and 450 were spread apart a relatively large distance, the gears would have to be very large in diameter to span the center distance, which could create cost, weight and packaging problems.

FIG. 3 illustrates an example of a shift actuator 600 (shifting system) that may be used in an embodiment. The shifting system 600 in this embodiment includes a sequential gear shifting assembly 603 and a gear range shifting assembly 701. In this embodiment the gear shifting assembly includes a shift drum 601. The shift drum 601 include a plurality of tracks 601a, 601b and 601c (cams). Although, the tracks 601a, 601b and 601c are illustrated as being generally perpendicular to an axis of rotation, they each will have a defined curved path at select locations to selectively activate gearing as discussed below. The shifting system 600 includes a first sequential shift fork 702 that is engaged with the first counter shaft shift dog 220. The first sequential shift fork 702 has a first tab follower portion 702a that is received in track 601c of the shift drum 601. Hence when the shift drum 601 rotates, the first sequential shift fork 702 following track 601c in the shift drum 601 may move to activate the first counter shaft shift dog 220 which in turn may couple rotation of the idler counter shaft reverse gear 218 or the first counter shaft gear 222 to the counter shaft 204.

The gear shifting assembly 603 of the shifting system 600 further includes a second sequential shift fork 704 that is engaged with the second counter shaft shift dog 230. The second sequential shift fork 704 has a tab follower portion 704a that is received in track 601b of the shift drum 601. Hence when the shift drum 601 rotates, the second sequential shift fork 704 following track 601b in the shift drum 601 may move to activate the second counter shaft shift dog 230 which in turn may couple rotation of the second counter shaft gear 224 or the third counter shaft gear 232 to the counter shaft 204.

The gear shifting assembly 603 of the shifting system 600 further includes a third sequential shift fork 706 that is engaged with the input shaft shift dog 240. The third sequential shift fork 706 has a tab follower portion 704a that is received in track 601a of the shift drum 601. Hence when the shift drum 601 rotates, the third sequential shift fork 706 following track 601a in the shift drum 601 may move to activate the input counter shaft shift dog 240 which in turn may couple rotation of the input shaft to the fourth input shaft gear 238 or the fifth input shaft gear 242. Hence, in this embodiment select rotation of the shift drum 601 sets the sequential gearing into either a reverse, a first, a second, a third, a fourth or a fifth gearing configuration.

As stated above, the shifting system 600 of this embodiment includes a gear range shifting assembly 701. The gear range shifting assembly 701 includes a gear range shaft 720 (push rod). The gear range shaft 720 has a first end 729a that engages a cam end 603 (face cam) of the shift drum 601. A gear range shift fork 708 is mounted on the gear range shaft 720. A biasing member 710 received around the gear range shaft 720 positioned between a gear case housing (not shown) and the gear range shift fork 708. The biasing member 710 biases the gear range shaft 702 to follow the cam end 603 of the shift drum 601. The gear range shift fork 708 is engaged with the intermediate shaft shift dog 320. Movement of the gear shift range shaft 720 and the fourth shift fork 708 selectively couples rotation of the intermediate shaft low range gear 310 or the intermediate shaft high gear 322 to the intermediate shaft 302. Hence, rotation of shift drum 601, in this example embodiment, also controls the high range and low range shifting. This arrangement allows for one shift actuator to be used and ensures the gear range shift fork 708 is in sync with the other shift forks 702, 704 and 706. Shifting actuation may include, but is not limited to, a manually operated linkage, pressurized oil or air driving a piston and an electrical actuator.

This configuration reduces the overall length of the shift drum. It may also help with packaging. A long, one-piece drum would have to be positioned such that it cleared the outside diameters of all gears it was shifting. The separate gear range shaft 702 (push-rod range fork shaft) is smaller in diameter than the shift drum 601, which helps it clear the range gears 310 and 322. The face cam 603 may be a separate component that is attached to the shift drum in an embodiment. Depending on how the drum is supported and positioned, this could allow the face cam 603 to be a larger diameter which in turn allows the range box fork shaft axis to move even farther away from the range gears 310 and 322. In addition, instead of the push rod arrangement described above, the activator may be a shift fork driven by a separate shift shaft input. Other types of shifting systems, including, but not limited to, non-index shifting systems could be implemented in embodiments.

In another embodiment, not shown, only a shift drum, such as shift drum 601 is used to shift the sequential gearing and the range gearing. In this embodiment, all cam/follower surfaces in the shift drum are circumferential tracks. The “range box” fork may have a pin-like feature that engages the track and is push/pulled directly by the shift drum without it needing to be spring biased as needed for the face cam design described above. This may create a relative long shift drum, or require a range gear shift fork having a pin to engage the drum that is offset a relatively large distance away from the plane of the fork feature that engages the shift dog. Moreover, in a full ratio range expansion embodiment, that includes a low and high gear for each sequential gear may also employ a relatively long shift drum.

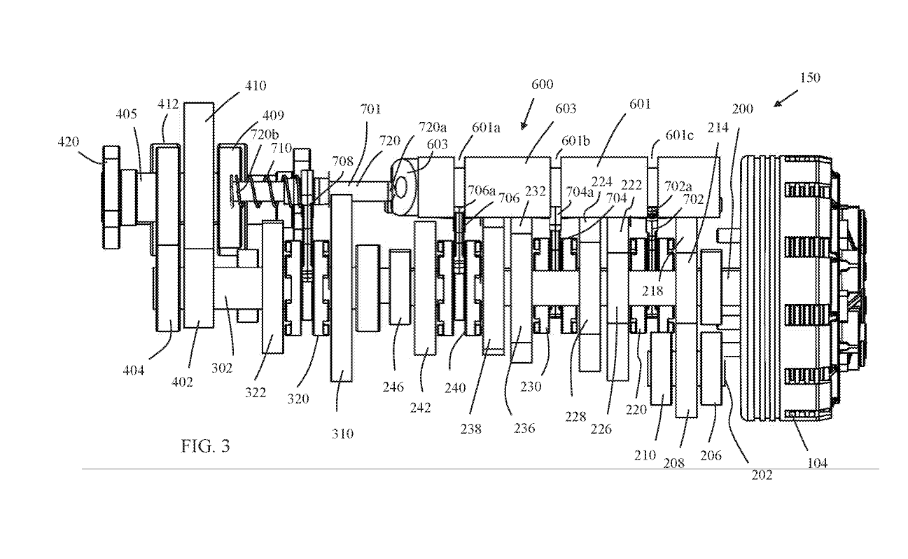

The sequential shift transmission 150 illustrated in FIGS. 2 through 6 illustrate one configuration. Depending on vehicle ratio, packaging, and layout needs, the power output may have different configurations. Shown in FIG. 2, the power flow (or torque 500) from the range box portion 108 through a reduction set (the intermediate shaft reduction gear 402 and the first output stage gear 410) is used to adjust the overall ratio and position output 420 in a desirable location. Moreover, a different gear set associated with outputs 420 and 450 (the first output stage gear 410 and the second output stage gear 414, which are illustrated as a 1:1 ratio in the Figures) with a different ratio may be used in other embodiments to offset the second output 450 in a different desired location. Moreover, the first output 420 and the second output 450 could be front and rear propeller shafts, or vice versa, depending on engine and vehicle layout. In additional, if it were desired to have a common front and rear output shaft, the 1:1 ratio gear set could be eliminated and both outputs could come off of the first output shaft 405. In addition if there is a desire to change the gear ratio split between first output 420 and the second output 450, the first output shaft 405 could be split into two stage gears instead of one (the first output stage gear 402). In this example configuration the intermediate shaft reduction gear 402 would be rotationally engaged with a first of the two stage gears and the second of the two stage gears would be rotationally coupled to first output stage gear 410. This would allow the use of different ratio front and rear axle final drive gear boxes. In addition, although a gear to gear description of the rotationally coupled first output stage gear 410 and the second output stage gear 414 is described, a chain and sprocket system could be used instead of the gear set to change the rotation of the second output 450.

Regarding the range portion 108 of the sequential shift transmission 150, depending on vehicle needs and ratios selected, shifting may be set up to provide various shifting options. For example, there could be six low range gears and six high range gears that overlap in ratio. Low range reverse, low range first (“granny-crawler gear”), and high range first thru fifth drive gears. In one embodiment, range gearing is only used to provide extra low gearing for slow speeds, not to expand the total number of forward driving gears. For reverse and crawler in embodiments, the shift drum 601 would engage either reverse or first gear and shift the range dog to the low range gear. To get first thru fifth, the range dog shifts to and stays in the high position in this example embodiment.

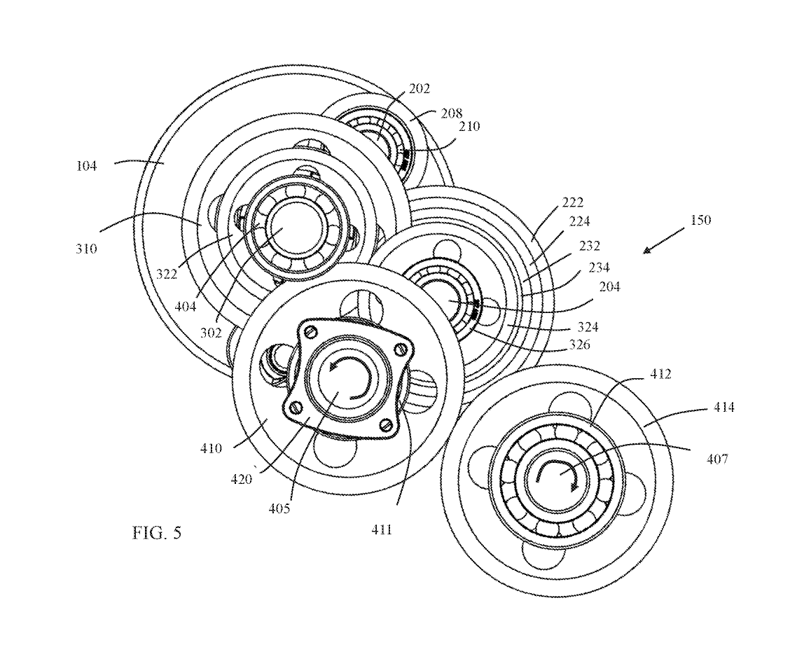

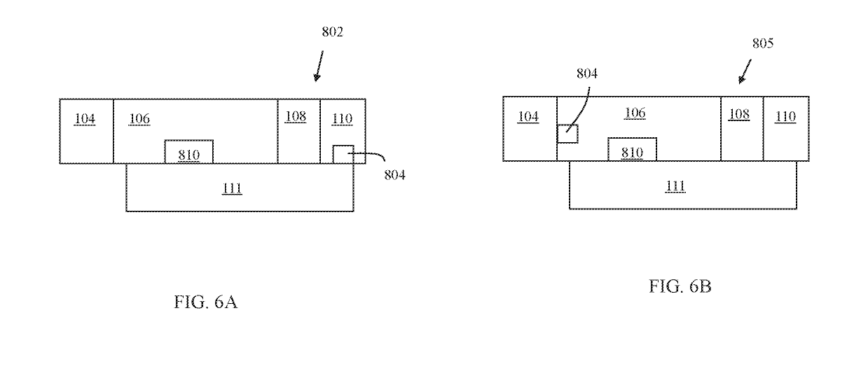

FIG. 6A illustrates a block diagram of a sequential transmission 802 of an embodiment that includes a park gear 810. The park gear 810 in this example is included in the sequential gearing of the transmission portion 106. The transmission portion 106 is operationally coupled to clutch 104 as discussed above. In this embodiment, the range gearing of the range box portion 108 is operationally coupled to the sequential gearing. The output provided by the transfer portion 110 is operationally coupled to the range gearing. In this embodiment, a primary reducing gear set 804 is included in the transfer portion 110. An example of the primary reducing gear set are the intermediate shaft reduction gear 402 and the first output stage gear 410 discussed above. In an alternative embodiment of a sequential transmission 805, the primary gear reduction set 804 is positioned directly after the clutch 104 as illustrated in FIG. 6B. This could help in packaging the engine/transmission to a vehicle chassis since it allows the main body of a transmission to be offset from the engine crank axis. Moreover, this reduced shaft speed of the relatively long main (input shaft 200) and counter shaft 204 may help with resonance concerns. In addition, this configuration reduces the relative speed between gears/dogs which may allow for tighter gear/dog backlash for reduced shift clunk and rattle. If more speed reduction is needed, there may be another stage of gear reduction added to which the output could be coupled. If even more speed reduction is needed, or if one simply needs to position the output shaft off-axis of the intermediate shaft 302, an additional gear set and shaft could be added. Moreover, if it is not desired to have a coaxial front and rear output from the transmission, another gear set and shaft could be added to position the second output shaft in a desired position. Hence, various configurations are contemplated based on the application.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A sequential shift transmission comprising:
a transmission portion having sequential gearing;
a range box portion having range gearing including a low range gear and a high range gear operationally coupled to the transmission portion;
a transfer portion operationally coupled to the range box portion to output torque from the sequential shift transmission; and
at least one shift actuator configured and arranged to selectively change the sequential gearing and the range gearing.

2. The sequential shift transmission of claim 1, wherein the at least one shift actuator uses a single input to control shifting of both the sequential gearing and the range gearing.

3. The sequential shift transmission of claim 2, wherein the single input is provided by one of a mechanical shift lever, an electric motor actuator, a hydraulic actuator and a pneumatic actuator.

4. The sequential shift transmission of claim 1, further comprising:
a park gear activated by the at least one shift actuator.

5. The sequential shift transmission of claim 1, wherein the at least one shift actuator further comprises:
a sequential gear shifting assembly configured and arranged to shift the sequential gearing; and
a gear range shifting assembly configured and arranged to shift the range gearing.

6. The sequential shift transmission of claim 5, further comprising:
the sequential gear shifting assembly including,
shift drum having at least one track,
at least one sequential shift fork operationally engaged with the at least one track,
and
at least one sequential shaft shift dog operationally engaged with the at least one sequential shift fork, the at least one sequential shaft shift dog configured and arranged to selectively lock rotation between a select gear of the sequential gearing and a sequential shaft to change gearing of the sequential gearing based on movement of the at least one sequential shift fork; and
the gear range shifting assembly including,
a gear range shaft in operational engagement with the shift drum,
a gear range shift fork operationally engaged to the gear range shaft, and
a gear range shaft shift dog operationally engaged with the range gearing, the gear range shaft shift dog configured and arranged to selectively lock rotation between one of the low gear and the high range gear and an intermediate shaft to change gearing of the range gearing based on movement of the gear range shift fork, the intermediate shaft being operationally coupled to the transfer portion to the sequential shift transmission.

7. The sequential shift transmission of claim 6, further comprising:
the shift drum including an end with a cam surface;
an end of the gear range shaft engaging the cam surface of the shift drum; and
a biasing member positioned to bias the gear range shaft against the cam surface, wherein rotation of the shift drum causes movement of the gear range shaft to change the range gearing in the range box.

8. The sequential shift transmission of claim 1, further wherein the transfer portion include at least one output that is configured and arranged to be operationally coupled to a drive shaft.

9. The sequential shift transmission of claim 1, further wherein the transfer portion further comprises:
a first output configured and arranged to be coupled to a first drive train; and
a second output operationally coupled to the first output, the second output being configured and arranged to be coupled to a second drive train.

10. The sequential shift transmission of claim 9, wherein the second output is positioned to not be coaxial with the first output.

11. The sequential shift transmission of claim 9, further comprising:
a reduction gear set positioned at least within one of the transmission portion and the transfer portion.

12. A sequential shift transmission comprising:
a transmission portion having sequential gearing;
a range box portion having range gearing including a low range and a high range operationally coupled to the transmission portion;
a transfer portion operationally coupled to the range box portion to output torque from the sequential shift transmission, the transfer portion including a reduction gear set; and
a shift actuator configured and arranged to selectively change both the sequential gearing and the range gearing of the sequential shift transmission.

13. The sequential shift transmission of claim 12, wherein the shift actuator further comprises:
a sequential gear shifting assembly configured and arranged to shift the sequential gearing; and
a gear range shifting assembly configured and arranged to shift the range gearing.

14. The sequential shift transmission of claim 13, further comprising:
the sequential gear shifting assembly including,
a shift drum having at least one track,
at least one sequential shift fork operationally engaged with the at least one track,
and
at least one sequential shaft shift dog operationally engaged with the at least one sequential shift fork, the at least one sequential shaft shift dog configured and arranged to selectively lock rotation between a select gear of the sequential gearing and a sequential shaft to change gearing of the sequential gearing based on movement of the at least one sequential shift fork; and
the gear range shifting assembly including,
a gear range shaft in operational engagement with the shift drum,
a gear range shift fork operationally engaged to the gear range shaft, and
a gear range shaft shift dog operationally engaged with the range gearing, the gear range shaft shift dog configured and arranged to selectively lock rotation between one of the low gear and the high range gear and an intermediate shaft to change gearing of the range gearing based on movement of the gear range shift fork, the intermediate shaft being operationally coupled to the transfer portion to the sequential shift transmission.

15. The sequential shift transmission of claim 14, further comprising:
the shift drum including an end with a cam surface;
an end of the gear range shaft engaging the cam surface of the shift drum; and
a basing member positioned to bias the gear range shaft against the cam surface, wherein rotation of the shift drum causes movement of the gear range shaft to change the range gearing in the range box.

16. A vehicle comprising:
an engine to provide torque;
a sequential shift transmission including,
a transmission portion having a sequential gearing arrangement for a plurality of sequential gears;
a range box portion having range gearing including a low range and a high range operationally coupled to the transmission portion; and
a transfer portion operationally coupled to the range box portion, the transfer portion configured and arranged to output torque from the transmission;
a clutch selectively coupling the torque from the engine to the transmission; and
at least one wheel operationally coupled to the transfer portion of the transmission.

17. The vehicle of claim 16, further comprising:
at least one drive shaft operationally coupled to the transfer portion.

18. the vehicle of claim 16, further comprising:
at least one shift actuator configured and arranged to selectively change the sequential gearing and the range gearing.

19. The vehicle of claim 18, wherein the at least one shift actuator further comprises:
a sequential gear shifting assembly configured and arranged to shift the sequential gearing; and
a gear range shifting assembly configured and arranged to shift the range gearing.

20. The vehicle of claim 19, further comprising:
the sequential gear shifting assembly including,
a shift drum having at least one track,
at least one sequential shift fork operationally engaged with the at least one track,
and
at least one sequential shaft shift dog operationally engaged with the at least one sequential shift fork, the at least one sequential shaft shift dog configured and arranged to selectively lock rotation between a select gear of the sequential gearing and a sequential shaft to change gearing of the sequential gearing based on movement of the at least one sequential shift fork; and
the gear range shifting assembly including,
a gear range shaft in operational engagement with the shift drum,
a gear range shift fork operationally engaged to the gear range shaft, and
a gear range shaft shift dog operationally engaged with the range gearing, the gear range shaft shift dog configured and arranged to selectively lock rotation between one of the low gear and the high range gear and an intermediate shaft to change gearing of the range gearing based on movement of the gear range shift fork, the intermediate shaft being operationally coupled to the transfer portion to the sequential shift transmission.
